(19) United States
(12) Patent Application Publication
(10) Pub. No.: US 2014/0149616 A1
(43) Pub. Date: May 29, 2014

(54) I2C BUS STRUCTURE AND ADDRESS MANAGEMENT METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: REN-HONG CHIANG, New Taipei (TW); DUN-HONG CHENG, Shenzhen (CN); YA-QIONG NIU, Shenzhen (CN)

(21) Appl. No.: 13/942,200

(22) Filed: Jul. 15, 2013

(30) Foreign Application Priority Data
Nov. 27, 2012 (CN) 2012104896902

(51) Int. Cl. G06F 13/364

(52) U.S. Cl. CPC G06F 13/364
USPC 710/110

(57) ABSTRACT

An Inter-Integrated Circuit (I2C) bus structure includes a master device, a slave device, and an address setter connected to each other via I2C buses. The slave device has an original device address. The master device transmits an address set command to the address setter. The address setter changes the first device address of the slave device to a second device address in response to the address set command. An address management method is also provided.

### REFERENCE TO RELATED APPLICATIONS

This application claims all benefits accruing under 35 U.S.C. §119 from China Patent Application No. 201210489690.2, filed on Nov. 27, 2012 in the State Intellectual Property Office of China. The contents of the China Application are hereby incorporated by reference. In addition, subject matter relevant to this application is disclosed in: co-pending U.S. patent application entitled “I2C BUS STRUCTURE AND DEVICE AVAILABILITY QUERY METHOD,” Attorney Docket Number US47437, Application No. [to be advised], filed on the same day as the present application; and co-pending U.S. patent application entitled “I2C BUS STRUCTURE AND COMMAND TRANSMISSION METHOD,” Attorney Docket Number US47438, Application No. [to be advised], filed on the same day as the present application. This application and the two co-pending U.S. patent applications are commonly owned, and the contents of the two co-pending U.S. patent applications are hereby incorporated by reference.

### BACKGROUND

1. Technical Field

The disclosure generally relates to bus structures, and particularly relates to Inter-Integrated Circuit (I2C) bus structure and address management methods for I2C bus structures.

2. Description of Related Art

For serial data communication between multiple devices, the Inter-Integrated Circuit (I2C) bus has been developed many years ago by Philips Semiconductors and has been widely accepted in the consumer electronics, telecommunications and industrial electronics fields. However, the greater the number of devices contained in an I2C bus structure is, the higher the complexity of the I2C bus structure becomes and accordingly the more hardware and software resources the I2C bus structure requires.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an I2C structure.

FIG. 2 is an example of a table showing original addresses of two slave devices.

FIG. 3 is a block diagram of an address setter connected to two slave devices.

FIG. 4 is an example of a table showing reset addresses of two slave devices.

FIG. 5 is a flowchart showing one embodiment of an address management method.

FIG. 6 is a block diagram of another embodiment of an I2C structure.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

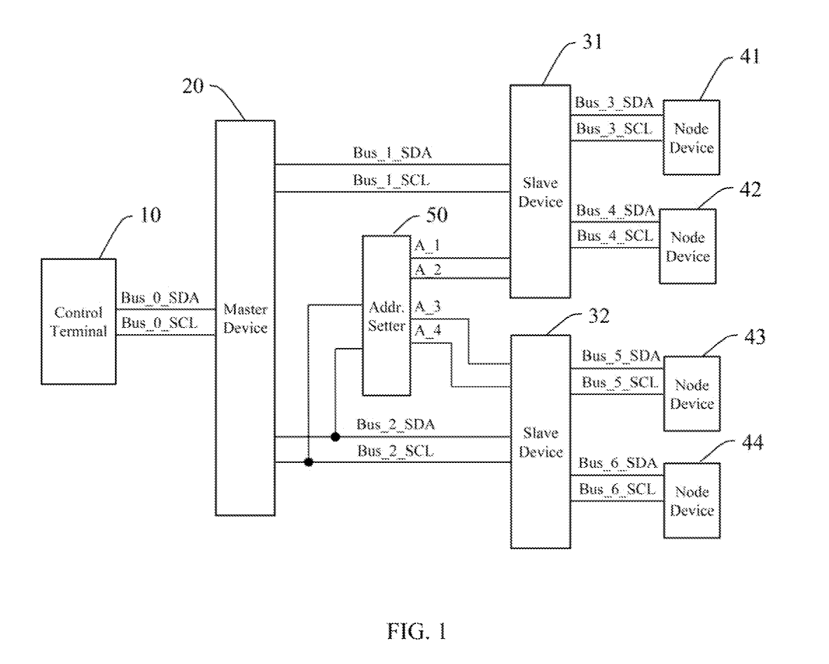

FIG. 1 shows one embodiment of an I2C structure. The I2C structure includes a control terminal 10, a master device 20, slave devices 31-32, and node devices 41-44. The number of slave devices and the node devices can be adjusted according to practical demands.

The control terminal 10 is connected to the master device 20 via an I2C bus Bus_0. The I2C bus Bus_0 includes a serial data line Bus_0_SDA and a serial clock line Bus_0_SCL. The control terminal 10 may transmit control commands to the master device 20 via the I2C bus Bus_0. The control terminal 10 may provide a user interface for receiving input from a user and outputting information.

The master device 20 is connected to the slave device 31 via an I2C bus Bus_1 and to the slave device 32 via an I2C bus Bus_2. The I2C bus Bus_1 includes a serial data line Bus_1_SDA and a serial clock line Bus_1_SCL. The I2C bus Bus_2 includes a serial data line Bus_2_SDA and a serial clock line Bus_2_SCL. The master device 20 may receive control commands from the control terminal via the I2C bus Bus_0 and transmit the control commands to the slave device 31 via the I2C bus Bus_1 or the slave device 32 via the I2C bus Bus_2.

The slave device 31 is connected to the node device 41 via an I2C bus Bus_3 and to the node device 42 via an I2C bus Bus_4. The I2C bus Bus_3 includes a serial data line Bus_3_SDA and a serial clock line Bus_3_SCL. The I2C bus Bus_4 includes a serial data line Bus_4_SDA and a serial clock line Bus_4_SCL. The slave device 31 may receive control commands from the master device 20 via the I2C bus Bus_1 and transmit the control commands to the node device 41 via the I2C bus Bus_3 or the node device 42 via the I2C bus Bus_4.

The slave device 32 is connected to the node device 42 via an I2C bus Bus_5 and to the node device 44 via an I2C bus Bus_6. The I2C bus Bus_5 includes a serial data line Bus_5_SDA and a serial clock line Bus_5_SCL. The I2C bus Bus_6 includes a serial data line Bus_6_SDA and a serial clock line Bus_6_SCL. The slave device 32 may receive control commands from the master device 20 via the I2C bus Bus_2 and transmit the control commands to the node device 43 via the I2C bus Bus_5 or the node device 44 via the I2C bus Bus_6.

The node devices 41-44 are located in the lowest layer of the I2C structure. The node devices 41-42 may receive control commands from the slave device 31 via the I2C buses Bus_3 and Bus_4 and perform corresponding actions in response to the received control commands. The node devices 43-44 may receive control commands from the slave device 32 via the I2C buses Bus_5 and Bus_6 and perform corresponding actions in response to the received control commands.

The master device 20 and the slave devices 31-32 may work in a hub mode or a switch mode. When the master device 20 and the slave devices 31-32 work in the hub mode, the master device 20 broadcasts control commands to each of the slave devices 31-32, the slave device 31 broadcasts control commands to each of the node devices 41-42, and the slave device 32 broadcasts control commands to each of the node devices 43-44. When the master device 20 and the slave devices 31-32 work in the switch mode, the master device 20 selectively transmits control commands to the slave devices 31-32, the slave device 31 selectively transmits control commands to the node devices 41-42, and the slave device 32 selectively transmits control commands to the node devices 43-44.

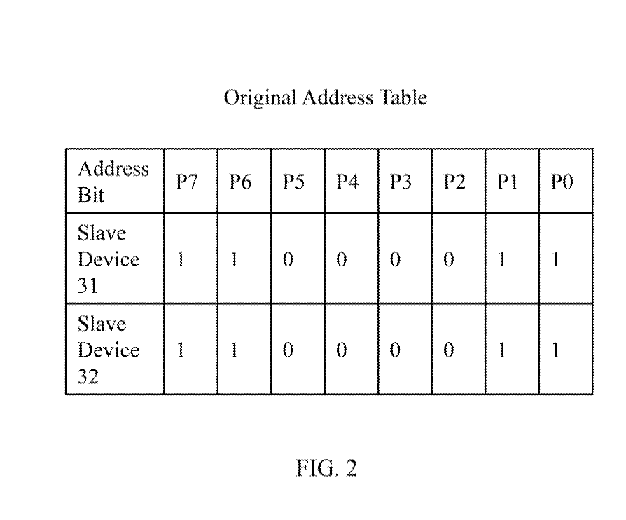

Each of the control terminal 10, the master device 20, the slave devices 31-32, and the node devices 41-44 is associated with a device address. Any two or more devices of the I2C structure having the same device address will result in an address conflict. In one embodiment, a device address includes eight bits. In an example illustrated in FIG. 2, the slave devices 31-32 have the same original address 11000011. Under this circumstance, the slave devices 31-32 will result in an address conflict.

To avoid the address conflict, the I2C bus structure further includes an address setter 50. The address setter 50 is connected to master device 20 via the I2C bus Bus_2. The address setter 50 may receive control commands from the master device 20 via the I2C bus Bus_2. In another embodiment, the address setter 50 is connected to master device 20 via the I2C bus Bus_1 and thus the address setter 50 may receive control commands from the master device 20 via the I2C bus Bus_1. In a third embodiment, the address setter 50 is connected to master device 20 via a standalone I2C bus other than the I2C bus Bus_2 or Bus_1.

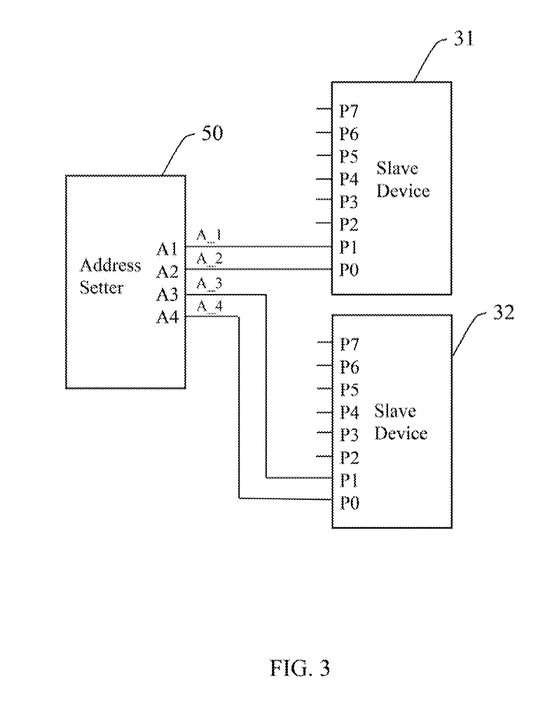

FIG. 3 shows that each of the slave devices 31 and 32 includes eight address pins P0-P7 corresponding to eight bits of a device address. When an electrical level of an address pin is low, it means that the value of a corresponding address bit is 0. When an electrical level of an address pin is high, it means that the value of a corresponding address bit is 1.

The address setter 50 includes four address setting pins A1, A2, A3, and A4. The address setting pins A1 and A2 are respectively connected to the address pins P1 and P0 of the slave device 31 via address lines A_1 and A2. The address setter 50 may set the electrical levels of the address pins P1 and P0 of the slave device 31 via the address setting pins A1 and A2. The address setting pins A3 and A4 are respectively connected to the address pins P1 and P0 of the slave device 32 via address lines A_3 and A_4. The address setter 50 may set the electrical levels of the address pins P1 and P0 of the slave device 32 via the address setting pins A3 and A4.

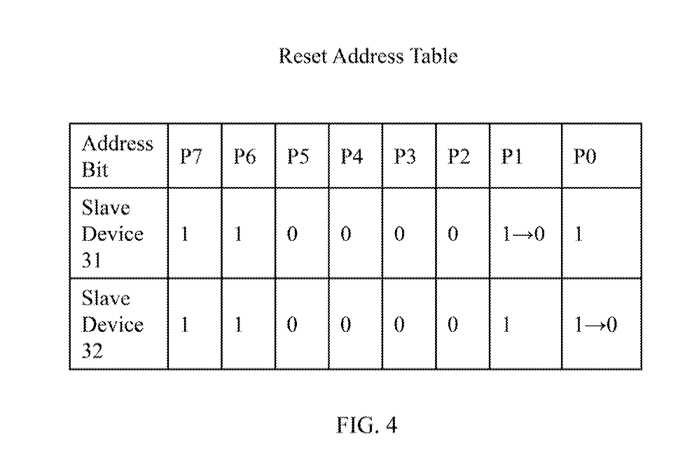

If the slave devices 31 and 32 has the same original device address, for example 1100011 as shown in FIG. 2, the address setter 50 may reset device addresses of the two slave devices 31 and 32. FIG. 4 shows that the address setter 50 sets the electrical level of the address pin P1 of the slave device 31 to low so that the device address of the slave device 31 is changed to 11000001. The address setter 50 sets the electrical level of the address pin P0 of the slave device 32 to low so that the device address of the slave device 32 is changed to 11000010. Thus each of the slave devices 31 and 32 has a unique device address.

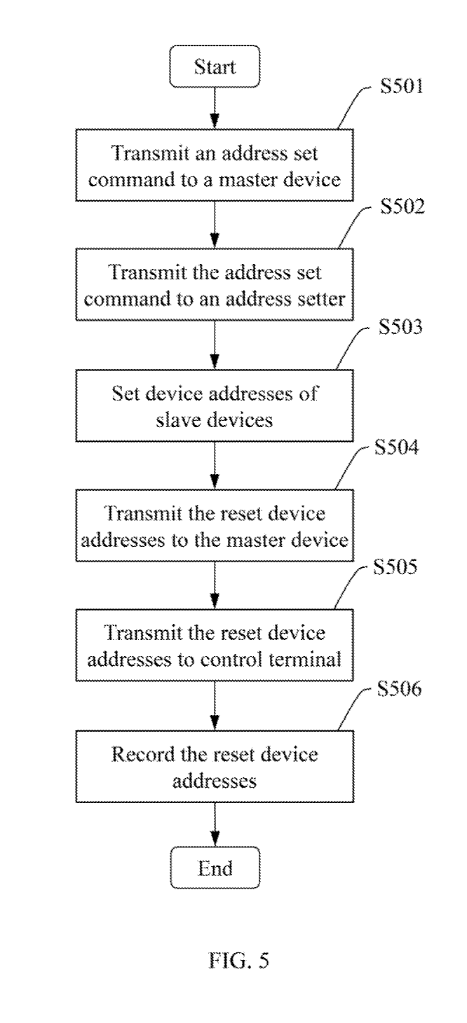

FIG. 5 is a flowchart showing one embodiment of an address management method. The method includes the following steps.

In step S501, the control terminal 10 transmits an address set command to the master device 20 via the I2C bus Bus_0.

In step S502, the master device 20 transmits the address set command to the address setter 50 via the I2C bus Bus_2.

In step S503, in response to the address set command, the address setter 50 sets the device address of the slave device 31 to a first reset device address via the address setting pins A1 and A2 and sets the device address of the slave device 32 to a second reset device address via the address setting pins A3 and A4. The first and second reset device addresses are distinct from each other. Thus, each of the slave devices 31 and 32 has a unique device address.

In step S504, the slave device 31 transmits the first reset device address to the master device 20 via the I2C bus Bus_1 to notify the master device 20 that the device address of the slave device 31 has been successfully reset. The slave device 32 transmits the second reset device address to the master device 20 via the I2C bus Bus_2 to notify the master device 20 that the device address of the slave device 32 has been successfully reset.

In step S505, the master device 20 transmits the first and second reset device addresses of the slave devices 31 and 32 to the control terminal 10 via the I2C bus Bus_0.

In step S506, the control terminal 10 records the first and second reset device addresses of the slave devices 31 and 32 so that the control terminal 10 can transmit control commands to the slave devices 31 and 32 through the first and second reset device addresses.

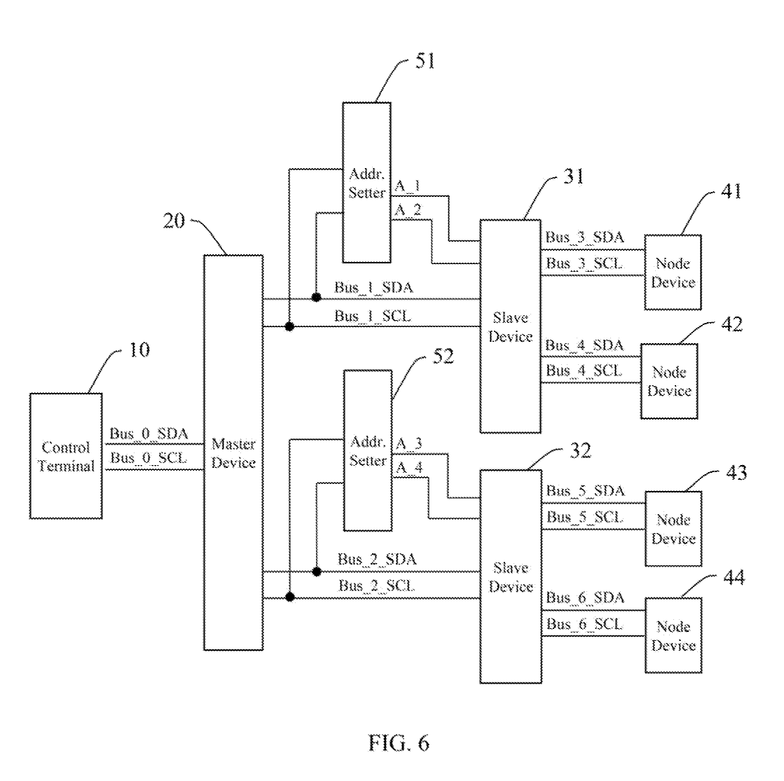

FIG. 6 shows another embodiment of an I2C structure. The I2C structure includes a control terminal 10, a master device 20, slave devices 31-32, and node devices 41-44. The I2C structure further includes two address setters 51 and 52. The address setter 51 is connected to the master device 20 via the I2C bus Bus_1. The address setter 52 is connected to the master device 20 via the I2C bus Bus_2. Each of the address setters 51 and 52 includes four address setting pins A1-A4. Each of the salve devices 31 and 32 includes eight address pins P0-P7 corresponding to eight bits of a device address.

The address setting pins A1 and A2 of the address setter 51 is connected to the address pins P1 and P0 of the slave device 31 via address lines A_1 and A_2. The address setter 50 may set the electrical levels of the address pins P1 and P0 of the slave device 31 via the address lines A_1 and A_2 thereby resetting the device address of the slave device 31.

The address setting pins A1 and A2 of the address setter 52 is connected to the address pins P1 and P0 of the slave device 32 via address lines A_3 and A_4. The address setter 50 may set the electrical levels of the address pins P1 and P0 of the slave device 32 via the address lines A_3 and A_4 thereby resetting the device address of the slave device 32.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An Inter-Integrated Circuit (I2C) bus structure, comprising:
a master device;
a slave device connected to the master device via a first I2C bus, the slave device being associated with a first device address; and
an address setter connected to the master device via a second I2C bus and to the slave device via an address line;
wherein the master device is adapted to transmit an address set command to the address setter, and the address setter is adapted to change the first device address of the slave device to a second device address in response to the address set command.

2. The I2C bus structure of claim 1, further comprising a control terminal connected to the master device via a third I2C bus, wherein the control terminal is adapted to transmit the address set command to the master device via the third I2C bus.

3. The I2C bus structure of claim 2, wherein the control terminal is further adapted to provide a user interface and receive control commands from a user through the user interface.

4. The I2C bus structure of claim 3, further comprising a plurality of node devices connected to the slave device via a plurality of fourth I2C buses, wherein the control terminal is adapted to transmit the control commands to the master device via the third I2C bus, the master device is adapted to transmit the control commands to the slave device via the first I2C bus, the slave device is adapted to transmit the control commands to the plurality of node devices via the plurality of fourth I2C buses.

5. The I2C bus structure of claim 2, wherein the slave device is adapted to transmit the second device address to the master device to notify the master device that the second device address of the slave device has been successfully set.

6. The I2C bus structure of claim 5, wherein the master device is adapted to transmit the second device address of the slave device to the control terminal via the third I2C bus, and the control terminal is adapted to transmit control commands to the slave device through the second device address.

7. The I2C bus structure of claim 1, wherein the first device address comprises a plurality of bits, the slave device comprises a plurality of address pins, an electrical level of each address pin corresponds to one of the plurality of bits of the first device address.

8. The I2C bus structure of claim 7, wherein the address setter comprises an address setting pin connected to one of the plurality of address pins of the slave device via the address line, the address setter is adapted to change the electrical level of the connected address pin via the address setting pin thereby changing the first device address of the slave device to the second device address.

9. The I2C bus structure of claim 1, wherein each of the first I2C bus and the second I2C bus comprises a serial data line and a serial clock line.

10. The I2C bus structure of claim 1, wherein the first I2C bus and the second I2C bus share the same bus lines.

11. An address management method, comprising:
connecting a master device to slave device via a first I2C bus, the slave device being associated with a first device address;
connecting an address setter to the master device via a second I2C bus and to the slave device via an address line;
transmitting an address set command to the address setter by the master device; and
changing the first device address of the slave device to a second device address in response to the address set command by the address setter.

12. The address management method of claim 11, further comprising:
connecting the master device to a control terminal via a third I2C bus; and
transmitting the address set command to the master device via the third I2C bus by the control terminal.

13. The address management method of claim 12, further comprising:
providing a user interface by the control terminal; and
receiving control commands from a user through the user interface.

14. The address management method of claim 13, further comprising:
connecting a plurality of node devices to the slave device via a plurality of fourth I2C buses;
transmitting the control commands to the master device via the third I2C bus by the control terminal;
transmitting the control commands to the slave device via the first I2C bus by the master device; and
transmitting the control commands to the plurality of node devices via the plurality of fourth I2C buses by the slave device.

15. The address management method of claim 12, further comprising transmitting the second device address to the master device by the slave device to notify the master device that the second device address of the slave device has been successfully set.

16. The address management method of claim 15, further comprising:
transmitting the second device address of the slave device by the master device to the control terminal via the third I2C bus;
transmitting the control commands to the slave device through the second device address by the control terminal

17. The address management method of claim 11, wherein the first device address comprises a plurality of bits, the slave device comprises a plurality of address pins, an electrical level of each address pin corresponds to one of the plurality of bits of the first device address.

18. The address management method of claim 17, further comprising:
connecting an address setting pin of the address setter to one of the plurality of address pins of the slave device via the address line; and
changing the electrical level of the connected address pin via the address setting pin by the address setter thereby changing the first device address of the slave device to the second device address.

19. The address management method of claim 11, wherein each of the first I2C bus and the second I2C bus comprises a serial data line and a serial clock line.

20. The address management method of claim 11, wherein the first I2C bus and the second I2C bus share the same bus lines.
